(19) United States
(12) Patent Application Publication
(10) Pub. No.: US 2013/0000169 A1
(43) Pub. Date: Jan. 3, 2013

(54) MOUNT FOR ARTWORK

(75) Inventors: Michael Ramos-Gonzalez, Epping (GB); Wayne Connelly, Gloucester City, NJ (US); David Pain, London (GB)

(73) Assignee: GMC MARKETING LIMITED, London (GB)

(21) Appl. No.: 13/386,271

(22) PCT Filed: Jul. 20, 2010
(86) PCT No.: PCT/GB2010/001370

§ 371 Date: Sep. 10, 2012

(30) Foreign Application Priority Data
Jul. 23, 2009 (GB) 0912842.2
Nov. 6, 2009 (GB) 0919469.7

(51) Int. Cl. A47G 1/06; B32B 38/00; B32B 37/12; B31D 99/00; B31D 3/02

(52) U.S. Cl. 40/773; 156/226; 156/60

(57) ABSTRACT

An image mounting system that comprises a mounting element and an image carrying element. The mounting element is a blank of foldable material with a substantially main portion that has at least one foldable extension to provide, in use, a three-dimensional mounting structure. An image carrying element that is larger than the main portion and is adhered to the main portion of the blank such that the image carrying element extends onto at least one foldable extension of the main portion.

The present invention relates to a mount for artwork. More especially, the invention relates to a display mount for any blank or printed, painted or otherwise decorated medium. The invention also relates to a method of construction and assembly of such a mount.

A number of different mediums on which art is printed or painted are available to the consumer.

The foregoing description primarily discusses artwork printed on a medium, it is clearly envisaged though the invention will equally apply to artwork painted or in any other way placed onto a medium. Moreover, it is envisaged that the artwork includes pictures, photographs and the like or images which do not necessarily have to have any artistic quality.

An increasingly popular medium is canvas. Traditionally the canvas carrying the printed artwork is stretched across a simple frame structure, usually made of wood. One such problem with the such methods of mounting a canvas is the need to re-stretch the canvas after periods of time. Although ways of re-stretching canvas have been simplified over the years it is still the case that the artwork starts to lose its quality while the canvas slowly loses its tension. Traditional stretching techniques require skills, know-how and specialist equipment and are relatively slow to perform.

The present invention seeks to alleviate the aforementioned disadvantage to provide a simple mount that is easy to construct and which is capable of retaining canvas, or any other medium on the mount in a way which does not deteriorate due to loss of tension. Furthermore the invention provides a mount that, in deconstructed form, requires very little storage space and which is easily transportable.

In one aspect there is provided, an image mounting system comprising a mounting element and an image carrying element, the mounting element being a blank of cardboard, or foldable material with a substantially main portion having at least one foldable extension to provide, in use, a three-dimensional mounting structure; an image carrying medium larger than the main portion, and means in use, to adhere the image carrying element to the main portion of the blank such that the image carrying element extends onto at least one foldable extension of the main portion.

The blank may alternatively be made from corrugated or honeycomb board.

Preferably the image is an artwork.

Preferably the image carrying element is a paper, canvas or similar medium.

Preferably the main portion of the blank is substantially rectangular.

Preferably part of the surface of the blank carries an adhesive. Alternatively or additionally an underside surface of the image carrying element carries adhesive.

Preferably still the adhesive is an acid-free adhesive.

Preferably the adhesive is covered by a protective layer that can be removed to expose the adhesive.

According to a second aspect there is provided a stiffening fitment for use in the system according to the first aspect.

According to a third aspect there is provided, a method of mounting a medium on a structure; the method comprising the steps of:

adhering the medium to a mount comprising a blank of cardboard, or foldable material with a substantially main portion having at least one foldable extension, such that the medium extends onto at least one foldable extension of the main portion;

folding the or each extension of the blank to provide, in use, a three-dimensional mounting structure.

The blank may alternatively be made from corrugated or honeycomb board.

Preferably the method further comprises the step of incorporating a stiffening element into or onto the mount.

According to a fourth aspect there is provided, a method of forming a corrugated board with an integral adhesive release-liner, the method comprising the steps of producing an adhesive laminate and incorporating the adhesive laminate into the corrugated board during the manufacturing process of the board.

The blank may alternatively be made from honeycomb board.

Preferably the adhesive laminate comprises a combination of white top kraft liner, a pressure sensitive adhesive and a siliconised release liner.

One embodiment of the invention will now be described, by way of example, with reference to the accompanying figures in which:

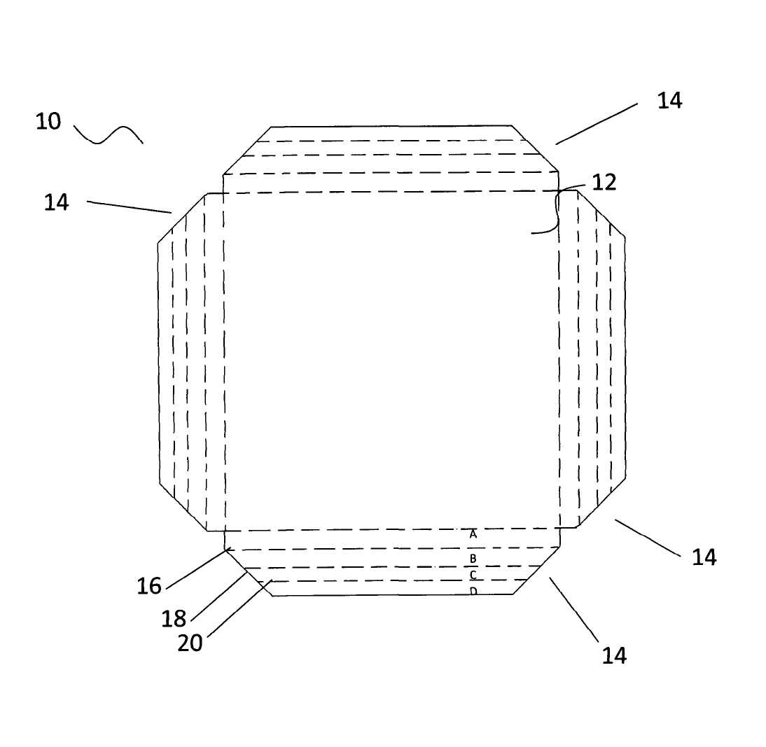

FIG. 1 illustrates a mounting element in its blank form in accordance with the invention;

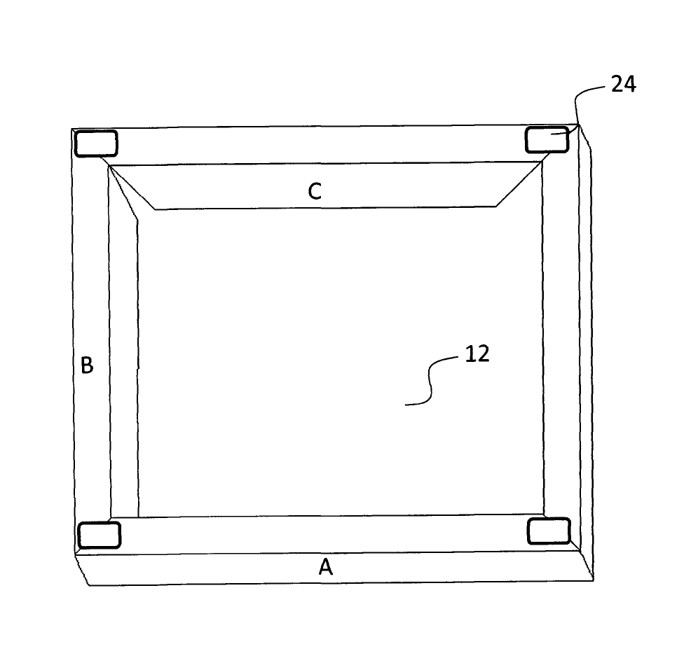

FIG. 2 illustrates the reverse of the mounting element of FIG. 1 in constructed form;

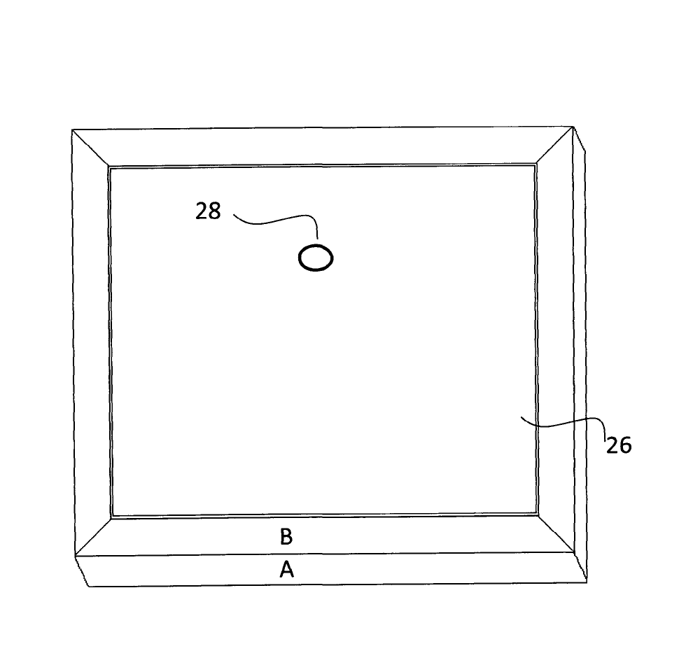

FIG. 3 illustrates the reverse of the mounting element of FIGS. 1 and 2 with a stiffening element;

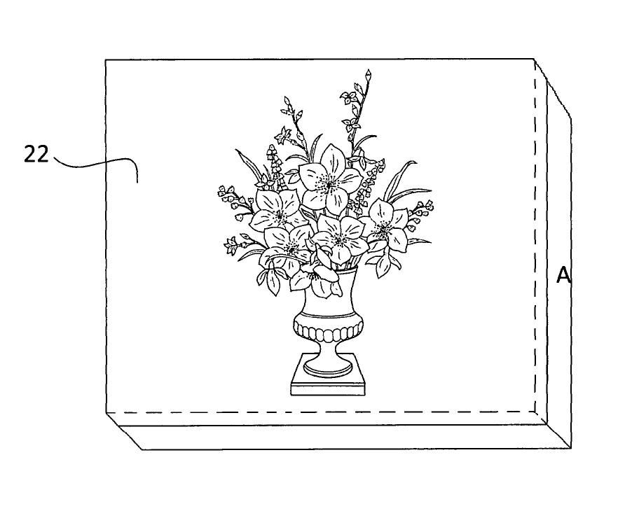

FIG. 4 illustrates the mounting element of FIGS. 1 to 3 carrying an image in accordance with the invention.

Referring first to FIG. 1, the invention comprises an image mounting element formed from a single blank 10 of cardboard or other foldable material.

The blank 10 has a generally rectangular portion 12 and four foldable extensions 14. Each extension 14 has three separate scored fold lines 16, 18, 20. The scored fold lines are shown in broken lines in the figures.

As can be seen with reference to FIG. 2, the extensions 14, in use are foldable to form a three-dimensional mount. FIG. 2 shows the mount, in constructed form, from the underside (i.e. as will be later described, a medium 22 carrying an image is adhered to other side of the rectangular portion as that shown in the illustration).

The folding mechanism of the extensions 14 will now be described. Note that in practice, the medium 22 will be adhered to the blank prior to the blank being folded.

To construct the three-dimensional mount, firstly tab A is folded inwards. This forms the perimeter wall of the mount. Tab B is then folded inwardly. This forms the back surface of the mount perimeter. Tab C is then folded inwards. This forms the inner perimeter wall. Finally Tab D is folded inwards to be adhered, or otherwise secured to, the inside surface of the rectangular portion 12 (tab D is not shown in the FIGS. 2 and 3).

The rectangular portion 12 and extension A are covered with a layer of adhesive. Preferably the adhesive extends over extensions B, C & D also.

The adhesive is preferably a non-acidic adhesive which would have no detrimental effect on either the cardboard blank 10 or the medium 22.

A protective cover is provided over the adhesive layer which can removed, simply by peeling, to expose the adhesive at the correct time.

In use, the protective cover is removed and the medium 22 is adhered to the rectangular potion 12, and at least extension A while the mount is in the blank form.

Each extension 14 is then folded in the manner as described to construct a three-dimensional mount. The medium 22, being adhered to the mount, is thereby supported on the structure.

The mount with a medium 22 carrying artwork adhered thereto is shown in FIG. 4.

Referring back to FIG. 2 now, the underside corners of the mount may be provided with some adhesive tape or felt 24 to provide a means to secure the assembly and/or provide protection for a wall in subsequent mounting and use.

In an alternative embodiment, the adhesive tape or felt may extend along the entire, or least the majority of the back surface of the mount perimeter.

FIG. 3 illustrates a further embodiment of the invention which includes a further rectangular structure or other stiffening element 26 that is placed within the back of the mount, between the perimeter walls to increase robustness and rigidity of assembly. The stiffening element 26 may have one or more apertures 28 in which to receive a traditional wall mount.

It will be appreciated that the mount described is generally rectangular, it is clearly envisaged that the mount could take the form of any shape, for example, a circle. In such a case the fold lines of the tabs will need to be re-shaped and, if necessary, cuts may be made in the tabs.

Although the above description discusses applying an adhesive layer to a board once formed, the Applicant envisages it being possible to incorporate an adhesive laminate into corrugated board or honeycomb board during the manufacturing process of the board itself. This will involve producing a custom made adhesive laminate comprising, for example, a 135 g white top kraft liner, a pressure sensitive adhesive and a siliconised release liner. The laminate is then applied to the corrugated board or honeycomb board during the manufacturing process.

It will be appreciated that the foregoing are merely examples of embodiments and just some examples of their use. The skilled reader will readily understand that modifications can be made thereto without departing from the true scope of the invention.

1. An image mounting system comprising
a mounting element and a image carrying element,
the mounting element being a blank of foldable material with a substantially main portion having at least one foldable extension to provide, in use, a three-dimensional mounting structure; and
an image carrying element larger than the main portion; and
means in use, to adhere the image carrying element to the main portion of the blank such that the image carrying element extends onto at least one foldable extension of the main portion.

2. An image mounting system according to claim 1, wherein
the foldable material is cardboard.

3. An image mounting system according to claim 1, wherein
the foldable material is honeycomb board.

4. An image mounting system according to claim 1, wherein
the foldable material is corrugated board.

5. An image mounting system according to claim 1, wherein
the image is an artwork.

6. An image mounting system according to claim 5, wherein
the image carrying element is a paper, canvas or similar medium.

7. An image mounting system according to claim 1, wherein
the main portion of the blank is substantially rectangular.

8. An image mounting system according to claim 1, wherein
part of the surface of the blank carries an adhesive.

9. An image mounting system according to claim 8, wherein
the adhesive is an acid-free adhesive.

10. An image mounting system according to claim 9, wherein
the adhesive is covered by a protective layer that can be removed to expose the adhesive.

11. An image mounting system according to claim 1, wherein
an underside surface of the image carrying element carries adhesive.

12. An image mounting system according to claim 1 further comprising
a stiffening fitment.

13. A method of mounting a medium on a structure, the method comprising the steps of:
adhering the medium to a mount comprising a blank of cardboard or foldable material with a substantially main portion having at least one foldable extension, such that the medium extends onto at least one foldable extension of the main portion;
folding each extension of the blank to provide, in use, a three-dimensional mounting structure.

14. A method of mounting a medium on a structure according to claim 13, wherein the method further comprises the step of
incorporating a stiffening element into or onto the mount.

15. A method of forming a corrugated board with an integral adhesive release-liner, the method comprising the steps of
producing an adhesive laminate and incorporating the adhesive laminate into the corrugated board during the manufacturing process of the board.

16. A method according to claim 15, wherein
the adhesive laminate comprises a combination of white top kraft liner, a pressure adhesive and a siliconised release liner.
